(19) United States
(12) Patent Application Publication
(10) Pub. No.: US 2023/0167001 A1
(43) Pub. Date: Jun. 1, 2023

(54) SYSTEMS AND METHODS FOR FABRICATING AN ARTICLE WITH AN ANGLED EDGE USING A LASER BEAM FOCAL LINE

(71) Applicant: CORNING INCORPORATED, Corning, NY (US)

(72) Inventors: Jason Roy Grenier, Horseheads, NY (US); Nickolaos Savidis, Grand Island, NY (US); Craig John Mancusi Ungaro, Corning, NY (US)

(21) Appl. No.: 17/993,320

(22) Filed: Nov. 23, 2022

Related U.S. Application Data
(60) Provisional application No. 63/284,258, filed on Nov. 30, 2021.

(51) Int. Cl. C03B 33/02; B23K 26/53; B23K 26/0622; B23K 26/384; C03B 33/04

(52) U.S. Cl. CPC C03B 33/0222; B23K 26/53; B23K 26/0624; B23K 26/384; C03B 33/04; B23K 26/08

(57) ABSTRACT

A method of separating a substrate includes directing a laser beam into the substrate such that a focal line is formed with at least a portion of the laser beam focal line within a bulk of the substrate at an oblique angle with respect to a laser-incident surface of the substrate. The laser beam focal line is formed by a pulsed laser beam that is disposed along a beam propagation direction. The method further includes pulsing the pulsed laser beam from a first edge of the substrate to a second edge of the substrate in a single pass. The laser beam focal line generates an induced multi-photon absorption within the substrate that produces a damage track within the bulk of the substrate along the laser beam focal line, and the damage track is at an oblique angle relative to the laser-incident surface of the substrate.

### CROSS REFERENCE TO RELATED APPLICATION

This application claims the benefit of priority under 35 U.S.C. § 119 of U.S. Provisional Application Ser. No. 63/284,258 filed on Nov. 30, 2021, the content of which is relied upon and incorporated herein by reference in its entirety.

### TECHNICAL FIELD

The present disclosure relates generally to laser cutting, and more particularly, to laser cutting of glass articles.

### BACKGROUND

Recently, glass articles having an angled edge have been popular. Particularly, the cover glass of mobile devices may have an angled edge for aesthetic purposes. These glass articles are fabricated by first separating several glass articles from a mother substrate using a mechanical or laser separation process. These glass articles are separated such that they have generally straight edges that are perpendicular to the major surfaces of the glass articles. These edges are then angled by a grinding and polishing process; however, the mechanical grinding and polishing process is an additional step that adds significant processing time. Further, the grinding and polishing process lowers yield because glass articles are frequently broken during the process, particularly in the case of thin glass articles.

Accordingly, alternative systems and methods for fabricating articles with angled edges may be desired.

### SUMMARY

Embodiments of the present disclosure are directed to fabricating articles with an angled edge using a laser process. The laser process removes or significantly reduces the grinding and polishing step to form the angled edges.

In one embodiment, a method of separating a substrate includes directing a laser beam into the substrate such that a laser beam focal line is within a bulk of the substrate at an oblique angle with respect to a laser-incident surface of the substrate. The laser beam is formed by a pulsed laser beam, and the laser beam is disposed along a beam propagation direction. The method further includes forming the pulsed laser beam such that the laser beam focal line extends from a first edge of the substrate to a second edge of the substrate in a single pass. The laser beam focal line generates an induced multi-photon absorption within the substrate that produces a damage track within the bulk of the substrate along the laser beam focal line, and the damage track is at an oblique angle relative to the laser-incident surface of the substrate. The method also includes providing relative motion between the pulsed laser beam and the substrate in a laser beam pass such that the pulsed laser beam forms a sequence of damage tracks within the substrate.

In another embodiment, a method of separating an article from a substrate includes directing a laser beam into the substrate such that a laser beam focal line is formed within a bulk of the substrate at an oblique angle with respect to a laser-incident surface of the substrate. The laser beam is formed by a pulsed laser beam, and the laser beam is disposed along a beam propagation direction. The pulsed laser beam passes through a phase modification device that applies a phase mask pattern to the pulsed laser beam. The laser beam focal line generates an induced multi-photon absorption within the substrate that produces a damage track within the bulk of the substrate along the laser beam focal line, and the damage track is at an oblique angle relative to the laser-incident surface of the substrate. The method further includes providing relative motion between the pulsed laser beam and the substrate in a laser beam pass such that the pulsed laser beam forms a sequence of damage tracks within the substrate. The method also includes applying a breaking force on the substrate to separate the article from the substrate at the sequence of damage tracks such that the article include an angled edge.

In yet another embodiment, a method of forming a conical hole in a substrate includes directing a laser beam into the substrate such that a laser beam focal line is formed within a bulk of the substrate at an oblique angle with respect to a laser-incident surface of the substrate. The laser beam is formed by a pulsed laser beam, and the laser beam is disposed along a beam propagation direction. The method also includes pulsing the pulsed laser beam such that the laser beam focal line generates an induced multi-photon absorption within the substrate that produces a damage track within the bulk of the substrate along the laser beam focal line, and the damage track is at an oblique angle relative to the laser-incident surface of the substrate. The method also includes providing relative rotational motion between the pulsed laser beam and the substrate in a laser beam pass such that the pulsed laser beam forms a sequence of damage tracks within the substrate that defines a circle.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the representative embodiments.

FIG. 1 schematically illustrates an example system for separating a substrate using a laser beam focal line according to one or more embodiments of the present disclosure;

FIG. 2 schematically illustrates an example system for separating a substrate at an angle using a laser beam focal line according to one or more embodiments of the present disclosure;

FIG. 3 schematically illustrates an example setup for evaluating aberrations in a laser beam due to entering a substrate at an angle according to one or more embodiments of the present disclosure;

FIG. 4 illustrates an example phase pattern for correcting aberrations in a laser beam according to one or more embodiments of the present disclosure;

FIG. 5A is a digital image of a laser beam spot within a substrate without phase modification;

FIG. 5B is a digital image of a laser beam spot within a substrate with phase modification according to one or more embodiments of the present disclosure;

FIG. 6 is a digital image showing a laser beam profile of a laser beam spot with phase modification according to one or more embodiments of the present disclosure;

FIG. 7 is a digital image of damage resulting from a laser line focus inside of a glass substrate wherein the laser beam entered the glass substrate at an angle and there was no phase modification;

FIG. 8 is a digital image of damage from a laser line focus inside of another glass substrate wherein the laser beam entered the glass substrate at an angle and there was no phase modification;

FIG. 9 is a digital image of damage from a laser line focus inside of a glass substrate wherein the laser beam entered the glass substrate at an angle and phase modification was provided according to one or more embodiments of the present disclosure;

FIG. 10 is a digital image of an angled edge of a glass article separated by a phase-corrected laser beam entering a glass substrate at an angle and forming a laser line focus according to one or more embodiments of the present disclosure;

FIG. 11A schematically illustrates a top surface of an article having a conical hole fabricated by an angled laser line focus according to one or more embodiments of the present disclosure; and

FIG. 11B schematically illustrates a cross sectional view of the glass article of FIG. 11A according to one or more embodiments of the present disclosure.

### DETAILED DESCRIPTION

Embodiments described herein relate to methods and systems for fabricating articles having an angled edge using a laser beam that reduces or eliminates grinding and/or polishing steps. Glass articles with angled edges are typically fabricated by first separating the glass articles from a mother substrate using a mechanical or laser separation process. These glass articles are separated such that they have generally straight edges that are perpendicular to the major surfaces of the glass articles. These edges are then angled by a grinding and polishing process.

However, traditional methods of fabricating glass articles (or articles made of other materials, such as glass-ceramic or silicon) by such mechanical grinding and polishing processes have significant disadvantages. Grinding and polishing are additional steps that add significant processing time, which also increases manufacturing costs. Further, the grinding and polishing process lowers yield because glass articles are frequently broken during the process, particularly in the case of thin glass articles.

Embodiments of the present disclosure address these problems by using a laser cutting process that forms an angled edge during the cutting process itself so that the grinding and polishing steps can be reduced or eliminated altogether. More particularly, an optical setup forms a laser beam with a focal spot which elongated into a laser line focus within the substrate that is angled with respect to a direction normal to the incidence surface of the substrate. Damage tracks or lines are formed along a laser beam propagation direction, and the substrate is broken along the sequential damage tracks to form an article having an angled edge.

However, a laser beam that enters a surface of a substrate at an angle (i.e., an angle other than normal to the incident surface of the substrate) has aberrations that prevent a strong laser line focus from forming within the substrate. The aberrations reduce the amount of damage that can be caused by the laser beam and thereby reduce the ability to separate articles from the substrate in a subsequent breaking process. As described in more detail below, embodiments also address the aberrations by use of phase modification.

Embodiments utilize an ultra-short pulsed laser and a specialized optical delivery system to create precise perforations (i.e., damage tracks) within the substrate. These perforations or damage tracks allow any crack propagation to be precisely controlled, preventing the glass sheet from shattering during the cutting process.

In accordance with methods described below, a laser can be used to create highly controlled full line perforation through a substrate, with extremely little (<75 μm, often <50 μm) subsurface damage and negligible debris generation. Thus, it is possible to create a microscopic (i.e., <2 μm and >100 nm in diameter) elongated “hole” or void (also referred to as a perforation, defect line, or damage track herein) in a transparent material using a single high energy pulse or burst pulse. These individual damage tracks (or “perforations”) can be created at rates of several hundred kilohertz (several hundred thousand perforations per second, for example). Thus, with relative motion between the source and the material these perforations can be placed adjacent to one another (spatial separation varying from sub-micron to tens of microns as desired). This spatial separation is selected in order to facilitate cutting. In some embodiments, the damage track is a “through hole”, which is a hole or an open channel that extends from the top to the bottom of the transparent material. In some embodiments, the damage track may not be a continuous channel, and may be blocked or partially blocked by portions or sections of solid material (e.g., glass). As defined herein, the internal diameter of the damage track is the internal diameter of the open channel or the air hole or void in the material. As a non-limiting example, in the embodiments described herein the internal diameter of the damage track is <500 nm, for example ≤400 nm, or ≤300 nm.

The wavelength of the laser is selected so that the material to be laser processed (drilled, cut, ablated, damaged or otherwise appreciably modified by the laser) is transparent to the laser wavelength. In one embodiment, the material to be processed by the laser is transparent to the laser wavelength if it absorbs less than 10% of the intensity of the laser wavelength per mm of thickness of the material. In another embodiment, the material to be processed by the laser is transparent to the laser wavelength if it absorbs less than 5% of the intensity of the laser wavelength per mm of thickness of the material. In still another embodiment, the material to be processed by the laser is transparent to the laser wavelength if it absorbs less than 2% of the intensity of the laser wavelength per mm of thickness of the material. In yet another embodiment, the material to be processed by the laser is transparent to the laser wavelength if it absorbs less than 1% of the intensity of the laser wavelength per mm of thickness of the material.

The selection of the laser source is further predicated on the ability to induce multi-photon absorption (MPA) in the transparent material. MPA is the simultaneous absorption of multiple photons (e.g. two, three, four or more) of identical or different frequencies in order to excite a material from a lower energy state (usually the ground state) to a higher energy state (excited state). The excited state may be an excited electronic state or an ionized state. The energy difference between the higher and lower energy states of the material is equal to the sum of the energies of the two or more photons. MPA is a nonlinear process that is several orders of magnitude weaker than linear absorption. In the case of two-photon absorption, it differs from linear absorption in that the strength of absorption depends on the square of the light intensity, thus making it a nonlinear optical process. At ordinary light intensities, MPA is negligible. If the light intensity (energy density) is extremely high, such as in the region of focus of a laser source (particularly a pulsed laser source), MPA becomes appreciable and leads to measurable effects in the material within the region where the energy density of the light source is sufficiently high. Within the focal region, the energy density may be sufficiently high to result in ionization, breaking of molecular bonds, and vaporization of material.

At the atomic level, the ionization of individual atoms has discrete energy requirements. Several elements commonly used in glass (e.g., Si, Na, K) have relatively low ionization energies (˜5 eV). Without the phenomenon of MPA, a wavelength of about 248 nm would be required to create linear ionization at ˜5 eV. With MPA, ionization or excitation between states separated in energy by ˜5 eV can be accomplished with wavelengths longer than 248 nm. For example, photons with a wavelength of 532 nm have an energy of ˜2.33 eV, so two photons with wavelength 532 nm can induce a transition between states separated in energy by ˜4.66 eV in two-photon absorption (TPA), for example.

Thus, atoms and bonds can be selectively excited or ionized in the regions of a material where the energy density of the laser beam is sufficiently high to induce nonlinear TPA of a laser wavelength having half the required excitation energy, for example. MPA can result in a local reconfiguration and separation of the excited atoms or bonds from adjacent atoms or bonds. The resulting modification in the bonding or configuration can result in non-thermal ablation and removal of matter from the region of the material in which MPA occurs. This removal of matter creates a structural defect (i.e., a perforation, defect line, or damage track) that mechanically weakens the material and renders it more susceptible to cracking or fracturing. By controlling the placement of damage tracks, a contour or path along which cracking occurs can be precisely defined to guide stress-induced microcracks between adjacent damage tracks. The contour defined by a series of damage tracks may be regarded as a fault line and corresponds to a region of structural weakness in the material.

Damage tracks can be accomplished with a single “burst” of high energy, short duration sub-pulses spaced close together in time. The laser pulse duration may be 10⁻¹⁰ s or less, or 10⁻¹¹ s or less, or 10⁻¹² s or less, or 10⁻¹³ s or less. These “bursts” may be repeated at high repetition rates (e.g. kHz or MHz). The damage tracks may be spaced apart and precisely positioned by controlling the velocity of a substrate or stack of substrates relative to the laser through control of the motion of the laser and/or the substrate. As an example, in a substrate moving at 200 mm/sec exposed to a 100 kHz series of pulses, the individual pulses would be spaced 2 microns apart to create a series of damage tracks separated by 2 microns. In some embodiments, the substrate is positioned on a translation table (not shown) capable of being translated along at least one axis. Any translation table or other device capable of translating either the glass substrate or the optical delivery head may be utilized.

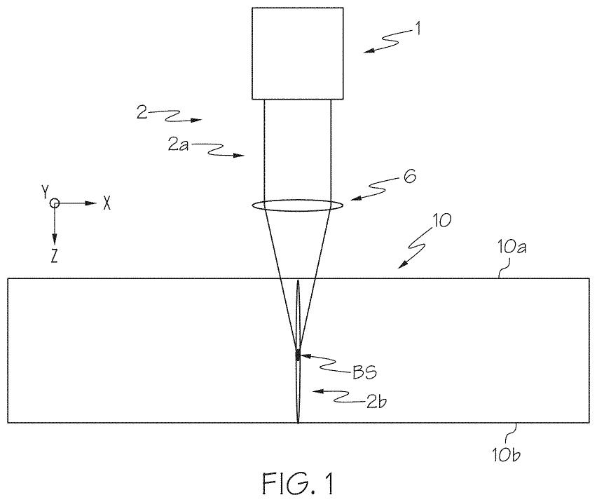

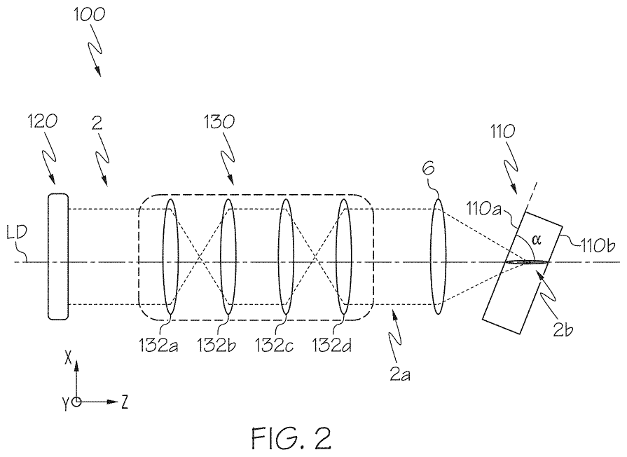

Turning now to FIG. 1, a non-limiting example system for laser drilling a substrate includes a laser source 1 and an optical system 6 for focusing a pulsed laser beam 2a into a laser beam focal line 2b having a central beam spot BS, viewed along the beam propagation direction. Laser beam focal line 2b is a region of high energy density. As shown in FIG. 2, laser 1 emits laser beam 2, which has a portion 2a incident to optical system 6. The optical system 6 turns the incident laser beam into an extensive laser beam focal line 2b on the output side over a defined expansion range along the beam direction (the length of the focal line).

Embodiments of the present disclosure utilize filamentation to form the laser beam focal line 2b using tightly focused Gaussian laser beams. The tight focus of a laser beam with a Gaussian intensity profile has a Rayleigh range ZR given by:

$${Z}_{R} = \frac{π {n}_{0} {w}_{0}^{2}}{{λ}_{0}} . \qquad Eq . ( 1 )$$

The Rayleigh range represents the distance over which the spot size wo of the beam will increase by \sqrt{2} in a material of refractive index η₀ at wavelength η₀. This limitation is imposed by diffraction. Note in Eq. (1) that the Rayleigh range is related directly to the spot size, thereby leading to the conclusion that a beam with a tight focus (i.e. small spot size) cannot have a long Rayleigh range. In the absence of filamentation, such a beam will maintain this small spot size only for a very short distance. This also means that if such a beam is used to drill through a material by changing the depth of the focal region, the rapid expansion of the spot on either side of the focus will require a large region free of optical distortion that might limit the focus properties of the beam. Such a short Rayleigh range also requires multiple pulses to cut through a thick sample.

However, embodiments of the present disclosure utilize filamentation to elongate the Gaussian beams discussed above. During filamentation, non-linear effects such as Kerr self-focusing and plasma formation can extend the focal region of a tight Gaussian focus to >100 μm. The central lobe of the filament can be quite small and thus produce a high-intensity beam. To further elongate the beam, a lens with multiple foci at various depths or multiple laser passes with varying focal depths may be used.

In general, the optical method of forming the laser focus can take multiple forms, such as, without limitation, spherical lenses, diffractive elements, or other methods to form the linear region of high intensity. The type of laser (picosecond, femtosecond, and the like) and wavelength (IR, visible, UV, and the like) may also be varied, as long as sufficient optical intensities are reached to create breakdown of the substrate material. As non-limiting examples, the wavelength may be 515 nm, 532 nm, 800 nm, 1030 nm, or 1064 nm.

The laser power and lens focal length (which determines the line focus length and hence power density) are parameters that ensure full penetration of the substrate for cutting. Accordingly, the dimensions of the line focus formed in the substrate should be controlled.

Referring once again to FIG. 1, a substrate 10 (e.g., glass) in which internal modifications by laser processing and multi-photon absorption is to occur is schematically illustrated. The substrate 10 may be disposed on a substrate or carrier. In some embodiments, multiple substrates 10 are arranged in a stack for simultaneous processing. The substrate 10 may be positioned on a translation table (not shown) configured to move along at least one axis. The translation table may be controlled by one or more controllers (not shown), for example. The substrate 10 is positioned in the beam path such that the focal spot of laser beam 2 is within the substrate and the focal spot elongates to a focal line 2b. The laser beam 2 may be generated by the laser source 1, which may be controlled by one or more controllers (not shown), for example. Reference 10a designates the surface of the substrate 10 facing (closest or proximate to) the optical system 6 or the laser, respectively, and reference 10b designates the reverse surface of substrate 10 (the surface remote, or further away from, optical system 6 or the laser).

As FIG. 1 depicts, substrate 10 is aligned perpendicular to the longitudinal beam axis and thus behind the same focal line 2b produced by the optical system 6 (the substrate is perpendicular to the plane of the drawing). Viewed along the beam direction, the substrate 10 is positioned relative to the focal line 2b in such a way that the focal line 2b (viewed in the direction of the beam) starts at the surface 10a of the substrate 10 and extends to surface 10b of the substrate 10. In another example, the focal line 2b terminates within the substrate 10. In the overlapping area of the laser beam focal line 2b with substrate 10, i.e. in the portion of substrate 10 overlapped by focal line 2b, the extensive laser beam focal line 2b generates nonlinear absorption in substrate 10. (Assuming suitable laser intensity along the laser beam focal line 2b, which intensity is ensured by adequate focusing of laser beam 2 on a section of length 1 (i.e. a line focus of length 1), which defines an extensive section (aligned along the longitudinal beam direction) along which an induced nonlinear absorption is generated in the substrate 10.) The induced nonlinear absorption results in formation of a damage track or crack in substrate 10 along the laser beam focal line 2b. The damage track or crack formation is not only local, but rather may extend over the entire length of the extensive section 2c of the induced absorption.

As FIG. 1 shows, the substrate 10 (which is transparent to the wavelength λ of laser beam 2) is locally heated due to the induced absorption along the focal line 2b. The induced absorption arises from the nonlinear effects associated with the high intensity (energy density) of the laser beam within focal line 2b. As non-limiting examples, the pulse energy may be in a range of 200 μJ to 1000 μJ, including endpoints.

The laser beam 2a may be a pulsed laser beam, such as a picosecond pulsed laser beam. In some embodiments, the picosecond laser described creates a “pulse burst” of a plurality of sub-pulses. Such a laser is referred to has a burst-mode laser. Producing pulse bursts is a type of laser operation where the emission of pulses is not in a uniform and steady stream but rather in tight clusters of sub-pulses. Each pulse burst contains multiple individual sub-pulses (such as at least 2 sub-pulses, at least 3 sub-pulses, at least 4 sub-pulses, at least 5 sub-pulses, at least 10 sub-pulses, at least 15 sub-pulses, at least 20 sub-pulses, or more) of very short duration. That is, a pulse bust is a packet of sub-pulses, and the pulse bursts are separated from one another by a longer duration than the separation of individual adjacent pulses within each burst. As non-limiting examples, the pulse width may be in a range of 50 fs to 10 ps, including endpoints.

Embodiments of the present disclosure provide for the fabrication of articles having an angled edge using an oblique angle laser filamentation defined by the line focus of the laser. Particularly, the methods and systems described herein provide for the cutting of a substrate, such as glass or glass-ceramic, with an angled edge (also referred to herein as a tapered edge or a chamfered edge) in a single pass using a filamented laser line focus process as described above. The line focus is formed inside of the substrate at an oblique angle with respect to an incident surface of the substrate. The line focus is then scanned across the substrate in a single pass to form a damage plane inside of the substrate. When stress is applied to the substrate, the substrate will then break along the damage line formed by the scanned line focus, thereby resulting in an article having an angled edge. In some embodiments, multiple passes can connect filaments at different angles, resulting in, for example, a C-chamfer.

When a laser beam enters a glass plate with an angled, curved, or stepped incident surface, aberrations are introduced into the beam. These aberrations may prevent a strong filament of the laser line focus from forming inside of the substrate. As described in more detail below, a combination of phase-correction and selection of optical setup and processing parameters may be used to reduce these aberrations to provide a smooth, angled edge. Manipulation of the non-linear effects may be used to provide proper corrections to form a strong filament line focus at an angle inside of the substrate. It is noted that the systems and methods described herein can also be applied to correct aberrations when cutting substrates with curved or stepped surface profiles. As such, the systems and methods of the present disclosure may be used to form a strong cutting filament inside a substrate having any arbitrary surface.

Referring now to FIG. 2, an example system 100 effectuating methods of cutting a substrate 110 such that the substrate 110 has an angled edge is illustrated.

The system 100 provides a method to efficiently convert a Gaussian laser beam 2a from a high-power laser system into an oblique angle line focus filament for substrate cutting, finishing, and other applications. A line focus is formed when a tightly focused beam undergoes self-focusing due to the Kerr effect.

The example 100 system is capable of cutting an edge of the substrate 110 in a single pass (i.e., multiple passes across a damage line are not needed). However, in some embodiments multiple passes across a damage line may be performed if desired. It should be understood that embodiments are not limited to the system 100 shown in FIG. 2, and that variations of the system are also possible. The example system 100 generally includes a phase modification device 120, imaging optics 130, and a focusing optical system 6 that forms the focal line 2b within the substrate 110. It is noted that there are many possible optical setups for the system that can achieve the same effect of creating a line focus filamentation within the substrate at an angle with respect to the incident surface.

Embodiments are not limited by the material of the substrate 110. Non-limiting examples of materials for the substrate include glass, glass-ceramic, and silicon.

As described in more detail below, the phase modification device 120 is operable to adjust the phase of the Gaussian laser beam 2a according to a phase pattern to remove or minimize laser aberrations within the laser beam 2a and the resulting focal line 2b that may affect the quality of the cut and resulting edge.

The imaging optics 130 may be provided to reform an image of the phase modification device 120 at a back focal plane of the optical system 6 (which may be configured as a focusing lens as described above). It is noted that in some embodiments the imaging optics 130 are not used and rather the focusing optical system 6 receives the image of the phase modification device 120 directly. In some embodiments, the imaging optics 130 provide a demagnification of the image of the phase modification device 120. Embodiments are not limited by any magnification value. As a non-limiting example, the demagnification factor may be within a range of 5 to 25, including endpoints, depending on the setup of the system 100. The optical system 6 may have a numerical aperture (NA) within a range of 0.2 to 0.6, including endpoints, for example.

The system 100 and the substrate 110 are arranged with respect to one another such that the focal line 2b is formed at an oblique angle α with respect to an incident surface 110a. In one example, the substrate 110 is positioned on an actuated base so that its position relative to the system focusing optical system 6 may be adjusted to adjust oblique angle α.

In the illustrated example, the focal line 2b extends from the incident surface 110a to an opposing surface 110b within the substrate 110; however, in other embodiments the focal line 2b may not extend all the way to the opposing surface 110b.

Once a focal line 2b is created inside the substrate 110, it can be scanned across the substrate to create a crack plane. In the setup of the system 100 shown in FIG. 2, the position of the substrate 110 and/or the system 100 is moved such that the focal line 2b is scanned in the Y-direction to form an angled damage plane within the substrate 110.

If stress is then applied to the substrate after the angled damage plane is formed, it will break through the laser damage plane to form an article having an angled edge. The stress may be in the form of a mechanical bending in some embodiments. In other embodiments, the stress may be provided by heating the substrate 110 and then rapidly cooling the substrate 110. The thermal shock provides thermally induced stress that will cause the substrate to break along the laser damage plane.

As stated above, aberrations within the laser beam 2a are caused by the oblique angle in which the laser beam 2a is incident on the incident surface 110a of the substrate 110. Thus, in embodiments of the present disclosure, a phase modification device 120 is provided within the system 100 to reduce or eliminate the aberrations of the laser beam 2a.

To find an appropriate modification of the phase of the laser beam 2a that leads to the formation of a desirable line focus substantially free of aberrations, a combination of modeling and experimental data may be utilized. First, modeled data may be used to gain an understanding of the type and severity of aberrations occurring in the beam. As a non-limiting example, the modeling software Zemax may be used to model the optical system. A Zemax model was designed to model an optical system as shown in FIG. 2. Raytracing modeling was performed in Zemax to determine the Zernike coefficients of the primary aberrations introduced into the laser beam by entering a tilted glass substrate. It was found from this modeling that the primary aberrations on the laser beam were Zernike polynomials 4-7 and 12-14 (OSA indexed). To limit parameter space, phase alterations to the beam by the SLM were constrained to these Zernike polynomials.

Due to these constraints and an imperfect optical system, a perfectly corrected beam was not achieved. While there are many aberration corrections that could lead to a bright focal spot inside the substrate, specific Zernike coefficients were chosen to provide a laser beam that smoothly came to a focus without high intensity zones. This was effective to prevent the formation of multiple filaments causing excess substrate damage outside the desired cutting zone. Additionally, processing parameters were chosen to keep the maximum intensity of the incoming beam low to prevent self-focusing of hotspots due to the optical Kerr effect.

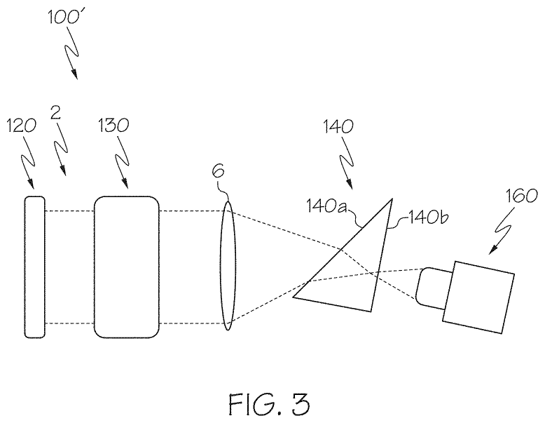

Then, experimental data consisting of images of aberrated spots in and above the focal region of the laser beam 2a were obtained using a system 100′ as shown in FIG. 3. The system 100′ of FIG. 3 is similar to that of the system 100 of FIG. 2 except for the inclusion of a prism 140 having an incident surface 140a that is angled with respect to an opposing surface 140b. A camera system 160 is also provided to image the laser beam as it exits the opposing surface 140b. Image data from the camera system 160 confirmed that the primary aberrations on the laser beam were Zernike polynomials 4-7 and 12-14.

Lastly, a genetic algorithm written in MATLAB by MathWorks® of Natick, Mass. was used to select a phase correction pattern that provided a laser beam which could produce the best possible line focus for cutting purposes. Experimental data from the camera was fed into the algorithm to achieve the desired outcome. More particularly, the genetic algorithm was used to search a parameter space consisting of the coefficients and center location of the previously mentioned Zernike polynomials. The merit function was calculated from data taken from camera images of the laser beam at two locations: (1) the beam spot BS focal region, and (2) a point 50 μm above the beam spot BS. The locations were chosen as a combination of the maximum intensity and the accuracy of a Gaussian fit. In the beam spot BS, the maximum intensity was maximized, while above the focal region the maximum intensity was minimized. This ensured a sharp focus with minimal hotspots in the laser beam above the beam spot BS. A high population (N>100) was used to minimize algorithm time because moving the camera system 160 for the merit function was the slowest part of the process. Multiple parameter sets in the population can be evaluated in parallel, resulting in faster convergence times for high population setups.

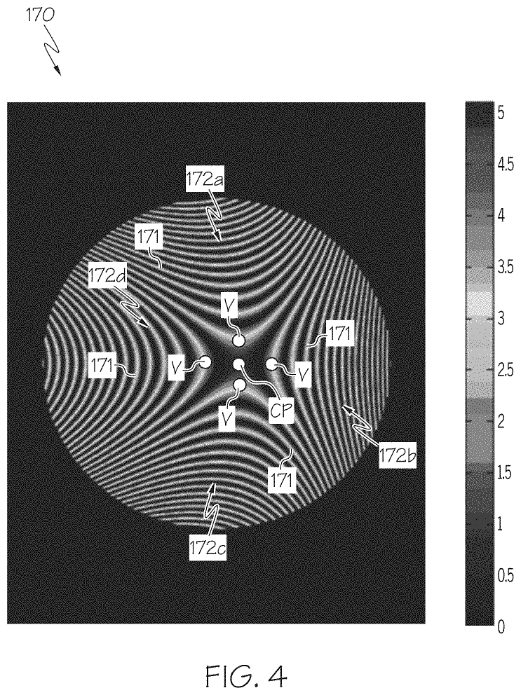

FIG. 4 illustrates an example phase pattern 170 designed using the process described above. The phase pattern 170 is operable to minimize or eliminate the aberrations of the laser beam caused by the laser beam being incident on an angled surface. The scale provided in FIG. 4 is the phase shift in radians. Although the example phase pattern 170 of FIG. 4 resulted in the highest merit function in the genetic algorithm, embodiments are not limited to the phase patterns of the illustrated phase pattern 170. It should be understood that the phase mask may have a different phase pattern depending on the optical setup of the system and the properties of substrate 110 (e.g., refractive index, thickness, and angle with respect to the focused laser beam).

The example phase pattern 170 of FIG. 4 has a plurality of parabolic phase-shifting bands 171. The plurality of parabolic phase-shifting bands 171 is arranged in sets of nested parabolic phase-shifting bands (i.e., first set 172A, second set 172B, third set 172C, and fourth set 172D). The sets of nested parabolic phase-shifting bands are arranged such that their vertices V face a center point CP of the phase pattern 170. Said differently, the vertices V of a first pair of sets of nested parabolic phase-shifting bands (e.g., the first set 172A and the third set 172C) oppose one another and the vertices of a second pair of sets of nested parabolic phase-shifting bands (e.g., the second set 172B and the fourth set 172D) oppose one another.

The phase manipulation device 120 shown in FIG. 2 is capable of applying the phase pattern 170 to the laser beam. The phase manipulation device 120 may be any device capable of modulating the phase of a laser beam and may include, but not limited to, a phase mask and a spatial light modulator.

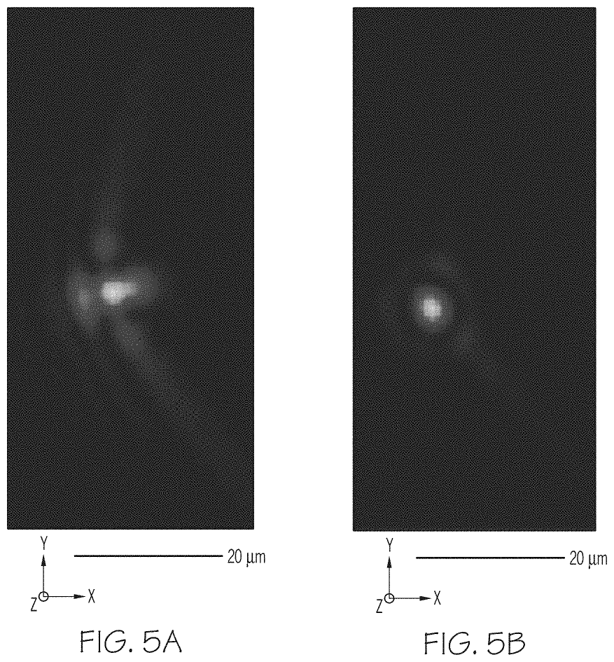

Referring now to FIG. 5A, a digital image of an uncorrected laser beam at the beam spot (i.e., the focal spot) using the setup of FIG. 3 with no phase modification device 120 is shown. The digital image of FIG. 5A clearly shows aberrations in the laser beam at the beam spot. FIG. 5B is a digital image of a corrected laser beam at the beam spot wherein a phase modification device 120 having the phase pattern 170 of FIG. 4. A comparison of the digital image of FIG. 5A and the digital image of FIG. 5B illustrates that the phase modification device 120 significantly removes aberrations. Also, the peak intensity of the beam spot of FIG. 5B was 2.4 times higher than the beam spot of FIG. 5A. It is noted that the intensities of the two digital images are scaled differently.

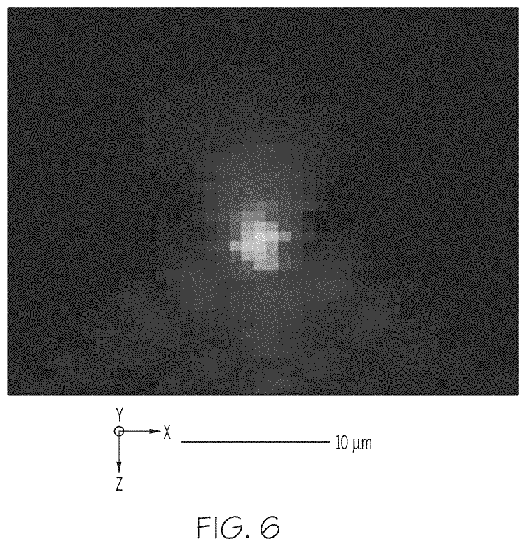

FIG. 6 illustrates a beam profile of a phase-corrected beam, showing minimal hotspots as the laser beam comes into focus.

### COMPARATIVE EXAMPLES

A system 100 according to FIG. 2 was used to separate two glass substrates configured as Corning® Gorilla® Glass (Code 2318) manufactured by Corning, Inc. of Corning N.Y. at an angle. The phase modification device 120 was configured to not apply a phase mask. The glass substrate was 200 μm thick and tilted at various angles with respect to the longitudinal direction LD of the system 100. The glass substrate was passed under a pulsed laser beam 2a having a wavelength of 1030 nm, a pulse energy of 400 μJ and 500 μJ, respectively, a repetition rate of 6 kHz, and a pulse width of 1 ps and 5 ps, respectively. The laser beam 2a was focused by an optical system 6 comprising lenses of numerical aperture (NA) 0.4 and 0.6, respectively, and the beam spot (i.e., focal spot) was located inside the glass substrate as it passed under the laser beam 2a.

In each case, the glass substrate was moved in the Y-direction with a speed such that there was an 8 μm pitch between adjacent laser shots. Under these conditions, a strong focal line 2b was produced inside of the glass substrate. As the glass substrate was passed under the focal line 2b, a long crack plane was formed.

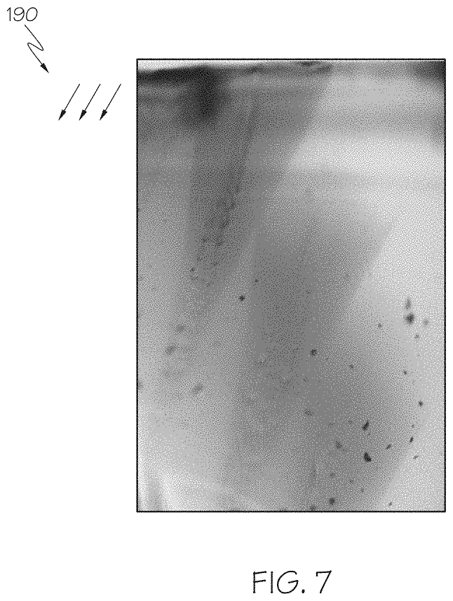

To view the damage, the glass substrates were cleaved in a plane perpendicular to the cracked region and examined under a microscope. FIG. 7 is a digital image of the damage resulting from a laser line focus inside of the glass substrate wherein the pulse energy was 400 μJ, the pulse width was 1 ps, and the optical system 6 comprised a 0.4 NA focusing lens. The incoming laser beam 2a was incident with a 30-degree angle relative to the normal of the incident surface of the glass substrate. Lines 190 illustrate the direction of the laser beam.

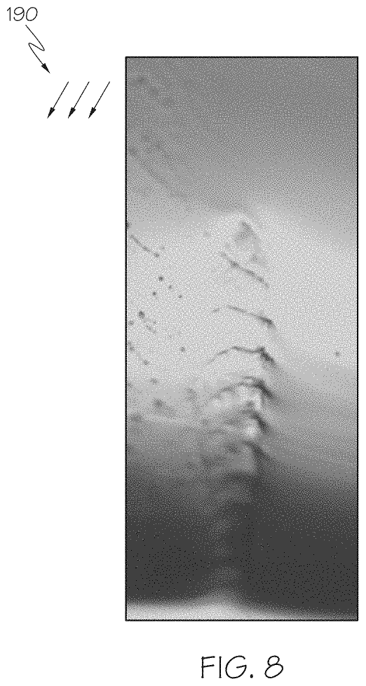

FIG. 8 is a digital image of the damage resulting from a laser line focus inside of the glass substrate wherein the pulse energy was 500 μJ, the pulse width was 5 ps, and the optical system 6 comprised a 0.6 NA focusing lens. The incoming laser beam 2a was incident with a 45-degree angle relative to the normal of the incident surface of the glass substrate. Lines 190 illustrate the direction of the laser beam.

As shown from FIGS. 7 and 8, aberrations leading to malformed filaments can be seen as a result of substrate angle. The aberrations grow worse with increased focal depth and substrate angle.

### Example 1

A glass substrate as described above with respect to the Comparative Examples was cut at a 45 degree angle using the system 100 of FIG. 2 except that the phase modulation device 120, which was configured as a spatial light modulator, applied the phase pattern 170 shown in FIG. 4. The glass substrate was tilted such that the incident surface of the glass substrate was 45 degrees with respect to the longitudinal direction LD of the system 100. The optical system 6 comprised a 0.6 NA focusing lens. The wavelength of the laser beam 2 was 1030 nm, the pulse energy was 400 μJ, and the pulse width was 10 ps to reduce the maximum beam intensity. It is noted that a burst-mode laser could also be used to reduce the maximum beam intensity. However, a burst-mode laser was not used in the Comparative Examples or Examples 1 and 2.

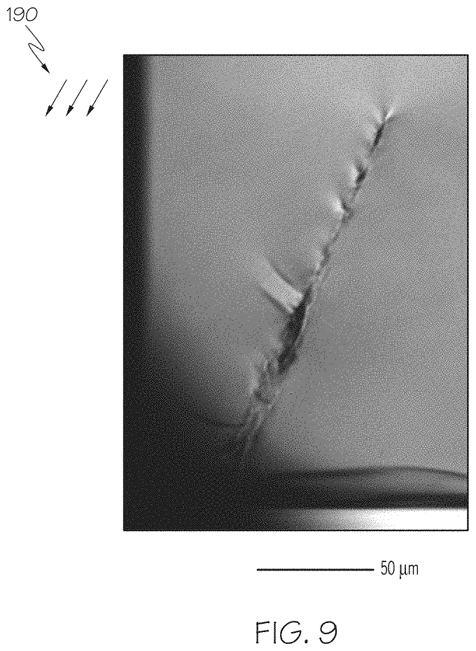

To view the damage, the glass substrate was cleaved in a plane perpendicular to the cracked region and examined under a microscope. FIG. 9 is a digital image of the damage resulting from a laser line focus inside of the glass substrate. Lines 190 illustrate the direction of the laser beam. As compared to FIGS. 7 and 8 of the Comparative Examples, increased damage and reduced aberrations in the filament formed by the laser line focus can be seen.

### Example 2

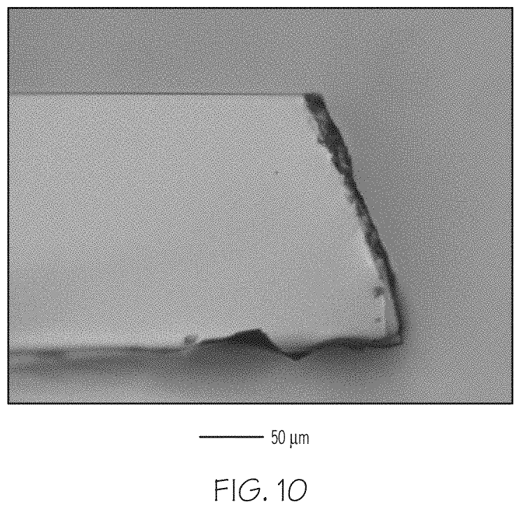

A 0.2 mm thick Corning® Gorilla® Glass (Code 2318) rectangular glass substrate was damaged by scanning a phase-corrected beam across it using the system 100 as described above and illustrated by FIG. 2. The incoming laser beam 2a was incident with a 45-degree angle relative to the normal of the incident surface of the glass substrate. The laser beam had a repetition rate of 3 kHz, a pulse energy of 400 μJ, a pulse width of 10 ps, and was focused with a 0.6 NA lens. The sample was moved under the laser beam at a rate such that adjacent laser pulses were 8 μm apart. A bending stress was then applied to the sample causing it to break on the damaged line. FIG. 10 is a digital image showing the resulting break imaged from the side using a microscope. A good, angled break can be seen.

The system 100 illustrated by FIG. 2 may also be used to fabricate cone-shaped holes within a substrate. Rather than linearly moving the substrate to form an edge, the substrate may be rotated with respect to the laser beam that is incident on an incident surface 210a of the substrate at an angle. The rotational motion of the substrate will form a conical damage line within the substrate. Upon application of stress (e.g., mechanical stress or thermal stress) or chemical etching, a central portion defined by the conical damage line of the substrate is removed. The removal of the central portion leaves behind a conical hole in the substrate.

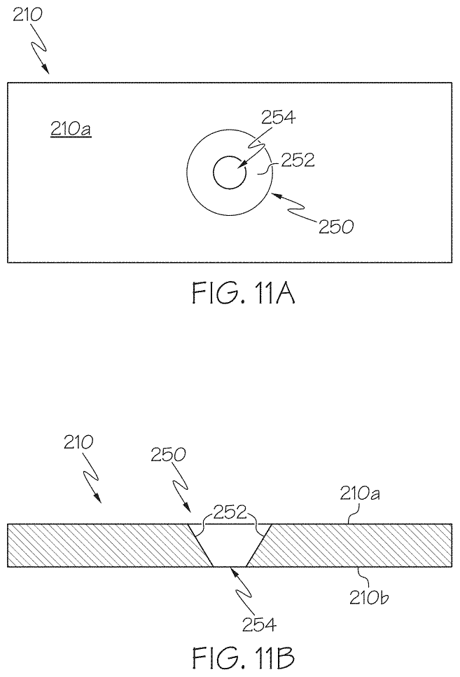

FIGS. 11A and 11B illustrate an example substrate 210 (which may be glass, glass-ceramic, or silicon, for example) having a conical hole 250 fabricated by rotating the substrate 210 with respect to a laser beam having a line focus. The conical hole 250 has a tapered wall that extends from an incident surface 210a to an opening 254 at an opposing surface 210b. It is noted that blind conical holes may be formed in a substrate by limiting a length of the laser line focus with the bulk of the substrate.

It should now be understood that embodiments described herein provide for systems and methods for fabricating an article having an angled edge using a laser beam having a line focus within a substrate. A phase modification device applies a phase pattern to the laser beam to remove aberrations due to the laser beam entering the substrate at an angle. Laser properties are adjusted to minimize local hotspots and produce a clean edge. In some embodiments, the laser line focus is used to form conical holes within a substrate.

The methods described herein are highly efficient. The filamentation process relies on self-focusing via the Kerr effect and nonlinear absorption in the substrate. This results in a long, thin energy deposition zone where the majority of the laser energy is absorbed in the cutting region, thereby resulting in a high efficiency cutting process.

Additionally, the single-pass process using high repetition rate lasers makes the cutting process very fast. The angled edges are of high quality that do not require the need for subsequent processes, such as grinding, polishing and/or etching. It is noted that grinding and polishing steps can result in sample loss, particularly on thin glass substrates. As grinding wheels wear, the edge profile resulting from the grinding process will change. Embodiments of the present disclosure create edge profiles that remain stable over time because there is no wear. The methods described herein provide a lower breakage rate as compared to traditional edge-finishing methods.

Further, the cutting methods of the present disclosure are low cost. The generation of this line focus can be accomplished with a phase mask applied via a diffractive optical element (DOE), deformable mirror, or SLM and several conventional optical elements. The total cost is relatively low compared to the laser and other parts. Additionally, this process has a much lower cost as compared to traditional grinding methods due to increased speed and reduced cost of operation (i.e., grinding wheels wear and need to be replaced quickly).

In a first aspect, a method of separating a substrate includes directing a focused laser beam into the substrate such that a laser beam focal line is formed within a bulk of the substrate at an oblique angle with respect to a laser-incident surface of the substrate. The laser beam focal line is formed by a pulsed laser beam, and the laser beam focal line is disposed along a beam propagation direction. The method further includes pulsing the pulsed laser beam from a first edge of the substrate to a second edge of the substrate in a single pass. The laser beam focal line generates an induced multi-photon absorption within the substrate that produces a damage track within the bulk of the substrate along the laser beam focal line, and the damage track is at an oblique angle relative to the laser-incident surface of the substrate. The method also includes providing relative motion between the pulsed laser beam and the substrate in a laser beam pass such that the pulsed laser beam forms a sequence of damage tracks within the substrate.

In a second aspect, a method according to the first aspect, further includes applying a breaking force on the substrate to separate an article from the substrate at the sequence of damage tracks, wherein the article has an angled edge.

In a third aspect, a method according to the first or second aspects, a phase modification device modifies a phase of the pulsed laser beam.

In a fourth aspect, a method according to the third aspect, wherein the phase modification device is operable to correct aberrations in the pulsed laser beam as compared to the pulsed laser beam prior to passing through the phase modification device.

In a fifth aspect, a method according to the fourth aspect, wherein the aberrations comprise one or more of Zernike polynomial 4-7 and Zernike polynomial 12-14.

In a sixth aspect, a method according to any one of the third through fifth aspects, wherein the phase modification device is one of a phase mask and a spatial light modulator.

In a seventh aspect, a method according to any one of the third through sixth aspects, wherein the phase modification device provides a phase pattern comprising a plurality of parabolic phase-shifting bands.

In an eighth aspect, a method according to the seventh aspect, wherein the plurality of parabolic phase-shifting bands includes a first pair of sets of nested parabolic phase-shifting bands and a second pair of sets of nested parabolic phase-shifting bands. The four sets of nested parabolic phase-shifting bands are radially arranged such that vertices of the sets of nested parabolic phase-shifting bands of the first pair oppose one another and vertices of the sets of nested parabolic phase-shifting bands of the second pair oppose one another.

In a ninth aspect, a method according to any preceding aspect, wherein the pulsed laser beam has a wavelength of 1030 nm, a pulse energy within a range of 200 μJ to 1000 μJ, including endpoints, and a pulse width within a range of 0.25 ps to 10 ps, including endpoints.

In a tenth aspect, a method of separating an article from a substrate includes directing a focused laser beam into the substrate such that a laser beam focal line is formed within a bulk of the substrate at an oblique angle with respect to a laser-incident surface of the substrate. The laser beam focal line is formed by a pulsed laser beam, and the laser beam focal line is disposed along a beam propagation direction. A phase modification device applies a phase mask pattern to the pulsed laser beam. The method also includes pulsing the pulsed laser beam. The laser beam focal line generates an induced multi-photon absorption within the substrate that produces a damage track within the bulk of the substrate along the laser beam focal line, and the damage track is at an oblique angle relative to the laser-incident surface of the substrate. The method further includes providing relative motion between the pulsed laser beam and the substrate in a laser beam pass such that the pulsed laser beam forms a sequence of damage tracks within the substrate. The method also includes applying a breaking force on the substrate to separate the article from the substrate at the sequence of damage tracks such that the article includes an angled edge.

In an eleventh aspect, a method according to the tenth aspect, wherein the phase modification device is operable to correct aberrations in the pulsed laser beam as compared to the pulsed laser beam prior to passing through the phase modification device.

In a twelfth aspect, a method according to the eleventh aspect, wherein the aberrations include one or more of Zernike polynomial 4-7 and Zernike polynomial 12-14.

In a thirteenth aspect, a method according to any one of the tenth through twelfth aspects, wherein the phase modification device is one of a phase mask and a spatial light modulator.

In a fourteenth aspect, a method according to any one of the tenth through thirteenth aspects, wherein the phase modification device provides a phase pattern including a plurality of parabolic phase-shifting bands.

In a fifteenth aspect, a method according to the fourteenth aspect, wherein the plurality of parabolic phase-shifting bands includes a first pair of sets of nested parabolic phase-shifting bands and a second pair of sets of nested parabolic phase-shifting bands. The four sets of nested parabolic phase-shifting bands are radially arranged such that vertices of the sets of nested parabolic phase-shifting bands of the first pair oppose one another and vertices of the sets of nested parabolic phase-shifting bands of the second pair oppose one another.

In a sixteenth aspect, a method according to any one of the tenth through fifteenth aspect, wherein the pulsed laser beam has a wavelength of 1030 nm, a pulse energy within a range of 200 μJ to 1000 μJ, including endpoints, and a pulse width within a range of 0.25 ps to 10 ps, including endpoints.

In a seventeenth, a method of forming a conical hole in a substrate includes directing a laser beam into the substrate such that a laser beam focal line is formed within a bulk of the substrate at an oblique angle with respect to a laser-incident surface of the substrate. The laser beam focal line is formed by a pulsed laser beam, and the laser beam focal line is disposed along a beam propagation direction. The method also includes pulsing the pulsed laser beam such that the laser beam focal line generates an induced multi-photon absorption within the substrate that produces a damage track within the bulk of the substrate along the laser beam focal line, and the damage track is at an oblique angle relative to the laser-incident surface of the substrate. The method also includes providing relative rotational motion between the pulsed laser beam and the substrate in a laser beam pass such that the pulsed laser beam forms a sequence of damage tracks within the substrate that defines a circle.

In an eighteenth aspect, a method according to the seventeenth aspect, further includes applying a mechanical force the circle to remove a circular portion of the substrate.

In a nineteenth aspect, a method according to the seventeenth or eighteenth aspects, further includes passing the pulsed laser beam through a phase modification device, wherein the phase modification device modifies a phase of the pulsed laser beam.

In a twentieth aspect, a method according to the nineteenth aspect, wherein the phase modification device is operable to correct aberrations in the pulsed laser beam as compared to the pulsed laser beam prior to passing through the phase modification device.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A method of separating a substrate, the method comprising:
directing a focused laser beam into the substrate such that a focal line is formed by filamentation within a bulk of the substrate at an oblique angle with respect to a laser-incident surface of the substrate, wherein the laser beam focal line is formed by a pulsed laser beam, and the laser beam focal line is disposed along a beam propagation direction;
applying the pulsed laser beam from a first edge of the substrate to a second edge of the substrate, wherein the laser beam focal line generates an induced multi-photon absorption within the substrate that produces a damage track within the bulk of the substrate along the laser beam focal line; and
providing relative motion between the pulsed laser beam and the substrate in a laser beam pass such that the pulsed laser beam forms a sequence of damage tracks within the substrate.

2. The method of claim 1, further comprising applying a breaking force on the substrate to separate an article from the substrate at the sequence of damage tracks, wherein the article comprises an angled edge.

3. The method of claim 1, wherein a phase modification device modifies a phase of the pulsed laser beam.

4. The method of claim 3, wherein the phase modification device is operable to correct aberrations in the pulsed laser beam as compared to the pulsed laser beam prior to passing through the phase modification device.

5. The method of claim 4, wherein the aberrations comprise one or more of Zernike polynomial 4-7 and Zernike polynomial 12-14.

6. The method of claim 3, wherein the phase modification device is one of a diffractive optical element, deformable mirror, and a spatial light modulator.

7. The method of claim 3, wherein the phase modification device provides a phase pattern comprising a plurality of parabolic phase-shifting bands.

8. The method of claim 7, wherein:
the plurality of parabolic phase-shifting bands comprises a first pair of sets of nested parabolic phase-shifting bands and a second pair of sets of nested parabolic phase-shifting bands; and
the first pair of sets of nested parabolic phase-shifting bands and the second pair of sets of nested parabolic phase-shifting bands are radially arranged such that vertices of the sets of nested parabolic phase-shifting bands of the first pair oppose one another and vertices of the sets of nested parabolic phase-shifting bands of the second pair oppose one another.

9. The method of claim 1, wherein the pulsed laser beam has a wavelength of 1030 nm, a pulse energy within a range of 200 μJ to 1000 μJ, including endpoints, and a pulse width within a range of 0.25 ps to 10 ps, including endpoints.

10. A method of separating an article from a substrate, the method comprising:
directing a focused laser beam into the substrate such that a laser beam focal line is formed by filamentation within a bulk of the substrate an oblique angle with respect to a laser-incident surface of the substrate, wherein:
the laser beam focal line is formed by a pulsed laser beam, and the laser beam focal line is disposed along a beam propagation direction; and
a phase modification device applies a phase mask pattern to the pulsed laser beam;
pulsing the pulsed laser beam, wherein the laser beam focal line generates an induced multi-photon absorption within the substrate that produces a damage track within the bulk of the substrate along the laser beam focal line;
providing relative motion between the pulsed laser beam and the substrate in a laser beam pass such that the pulsed laser beam forms a sequence of damage tracks within the substrate; and
applying a breaking force on the substrate to separate the article from the substrate at the sequence of damage tracks, where in the article comprises an angled edge.

11. The method of claim 10, wherein the phase modification device is operable to correct aberrations in the pulsed laser beam as compared to the pulsed laser beam prior to passing through the phase modification device.

12. The method of claim 11, wherein the aberrations comprise one or more of Zernike polynomial 4-7 and Zernike polynomial 12-14.

13. The method of claim 10, wherein the phase modification device is one of a diffractive optical element, deformable mirror, and a spatial light modulator.

14. The method of claim 10, wherein the phase modification device provides a phase pattern comprising a plurality of parabolic phase-shifting bands.

15. The method of claim 14, wherein:
the plurality of parabolic phase-shifting bands comprises a first pair of sets of nested parabolic phase-shifting bands and a second pair of sets of nested parabolic phase-shifting bands; and
the first pair of sets of nested parabolic phase-shifting bands and the second pair of sets of nested parabolic phase-shifting bands are radially arranged such that vertices of the sets of nested parabolic phase-shifting bands of the first pair oppose one another and vertices of the sets of nested parabolic phase-shifting bands of the second pair oppose one another.

16. The method of claim 10, wherein the pulsed laser beam has a wavelength of 1030 nm, a pulse energy within a range of 200 μJ to 1000 μJ, including endpoints, and a pulse width within a range of 0.25 ps to 10 ps, including endpoints.

17. A method of forming a conical hole in a substrate, the method comprising:
directing a focused laser beam into the substrate such that a laser beam focal line is formed by filamentation within a bulk of the substrate at an oblique angle with respect to a laser-incident surface of the substrate, wherein the laser beam focal line is formed by a pulsed laser beam, and the laser beam focal line is disposed along a beam propagation direction;
pulsing the pulsed laser beam, wherein the laser beam focal line generates an induced multi-photon absorption within the substrate that produces a damage track within the bulk of the substrate along the laser beam focal line; and
providing relative rotational motion between the pulsed laser beam and the substrate in a laser beam pass such that the pulsed laser beam forms a sequence of damage tracks within the substrate that defines a circle.

18. The method of claim 17, further comprising applying a mechanical force to the circle to remove a circular portion of the substrate.

19. The method of claim 17, further comprising passing the pulsed laser beam through a phase modification device, wherein the phase modification device modifies a phase of the pulsed laser beam.

20. The method of claim 19, wherein the phase modification device is operable to correct aberrations in the pulsed laser beam as compared to the pulsed laser beam prior to passing through the phase modification device.
